(19) United States
(12) Patent Application Publication
(10) Pub. No.: US 2008/0092389 A1
(43) Pub. Date: Apr. 24, 2008

(54) Method for Mounting a Mass Balancing Drive on a Crank Housing of an Internal Combustion Engine Comprising a Crankshaft

(76) Inventors: Michael Neitz, Aachen (DE); Ralf Gruner, Koln (DE); Wolfgang Germscheid, Duren (DE)

Correspondence Address: GIFFORD, KRASS, SPRINKLE,ANDERSON & CITKOWSKI, P.C, PO BOX 7021, TROY, MI, 48007-7021, US

(21) Appl. No.: 11/570,048

(22) PCT Filed: Jun. 1, 2005
(86) PCT No.: PCT/EP05/05891

§ 371 Date: Dec. 5, 2006

(30) Foreign Application Priority Data
Jun. 5, 2004 (DE) 10 2004 027 588.2

(51) Int. Cl. F02B 67/04; F02F 7/00; F16F 15/26

(52) U.S. Cl. 29/893.2; 464/180

(57) ABSTRACT

The invention relates to a method for mounting, in a simple manner, a mass differential gear (4) onto a crank housing (1) of an internal combustion engine. An intermediate gearwheel (9), which can be pivoted about an axis, is arranged between the crankshaft gearwheel (10) and the subsequent drive gearwheel (7), said axis being located on the connection line of the axis of the intermediate gearwheel (9) and the drive gearwheel (7) driven thereby. After fixing the housing (5) of the mass differential gear (4), the intermediate gearwheel (9) is rotated about the axis until zero play is reached between the intermediate gearwheel (9) and the crankshaft gearwheel (10). The measuring distance between the housing (5) and the contact surface (3) is measured at zero play and the measuring distance necessary for achieving the desired flank play is determined between the intermediate gearwheel (9) and the crankshaft gearwheel (10), and an intermediate layer (15) corresponding to the measuring distance is introduced between the housing (5) and the contact surface (3) whereon the intermediate gearwheel (9) is fixed.

### FIELD OF THE INVENTION

The invention relates to a method of mounting a mass balancing drive on a crank housing of an internal combustion engine comprising a crankshaft.

### BACKGROUND OF THE INVENTION

To achieve improved smoothness of running characteristics of four-cylinder engines it is known to provide suitable mass balancing drives. For example, Lancaster drives used for this purpose substantially consist of two out-of-balance or equalizing shafts which rotate in opposite direction and at double the engine speed The horizontal components of inertia forces balance one another. However the vertical components are summed and counterbalance the free forces of the second order of the crank drive. Thus, in an ideal way, the vertical components eliminate the free forces of the second order of the crank drive completely, so that no forces are introduced into the engine mounting. This result achieves a substantial improvement both in acoustic and wear-technical respects.

However, such mass balancing drives generally require complicated assembling procedures because it is necessary to set the tooth flank play with the necessary tolerances during the process of assembling the mass balancing drive.

For example, from DE 101 23 735 A1 it is known to displaceably arrange the mass balancing drive in a suitable mounting region at the crank housing. One suitable mounting region is in the plane of a contact face between the mass balancing drive and the crank housing. This location affords for displacing said balancing drive in a direction transversely to the longitudinal axis of the crankshaft thereby allowing a predetermined tooth flank play to be obtained in the engaged condition between a gear of the mass balancing drive and a gear on the crankshaft. The engaged condition is then fixed in this position relative to the crank housing.

### SUMMARY OF THE INVENTION

The present invention provides a method permitting a simplified assembling procedure for setting of a tooth flank play of a gear drive of a mass balancing drive. The method includes an intermediate gear arranged between a crankshaft gear and a following drive gear. The intermediate gear is pivotable around a pivot axis, said axis positioned on a connecting line. The connecting line intersects the axis of the intermediate gear and the axis of the driving gear. The intermediate gear is swung around the pivot axis up to a point of zero play between the intermediate gear and the crankshaft gear. The position of zero play defines a distance between a housing cover and a contact face. A predetermined nominal distance value representative of a desired amount of flank play is added to the distance between the housing cover and contact face and an intermediate layer equal to the total distance is arranged or inserted between said cover and face. Positioning of the intermediate layer between said cover and face fixes the intermediate gear with a desired amount of flank play.

Furthermore, the invention relates to a mass balancing drive for an internal combustion engine, said drive having a housing in which there are supported two equalizing shafts. The two shafts rotate in opposite directions and can be driven by two inter-engaging driving gears. An intermediate gear engages one of the driving gears and is pivotable around an axis positioned on a connecting line that intersects the axis of the intermediate gear and the axis of the driving gear driven thereby. The method affords the location of the intermediate gear to be fixed in a predetermined position relative to the housing.

Further embodiments of the invention can be gathered from the following description and the claims, and the invention is described in greater detail with reference to embodiments diagrammatically illustrated in the attached figures.

### BRIEF DESCRIPTION OF THE DRAWINGS

FIG. 1 is a diagrammatic illustration of a front view of an embodiment of a crank housing and a mass balancing drive; and

FIG. 2 is a view X of FIG. 1.

### DETAILED DESCRIPTION OF THE PREFERRED EMBODIMENTS

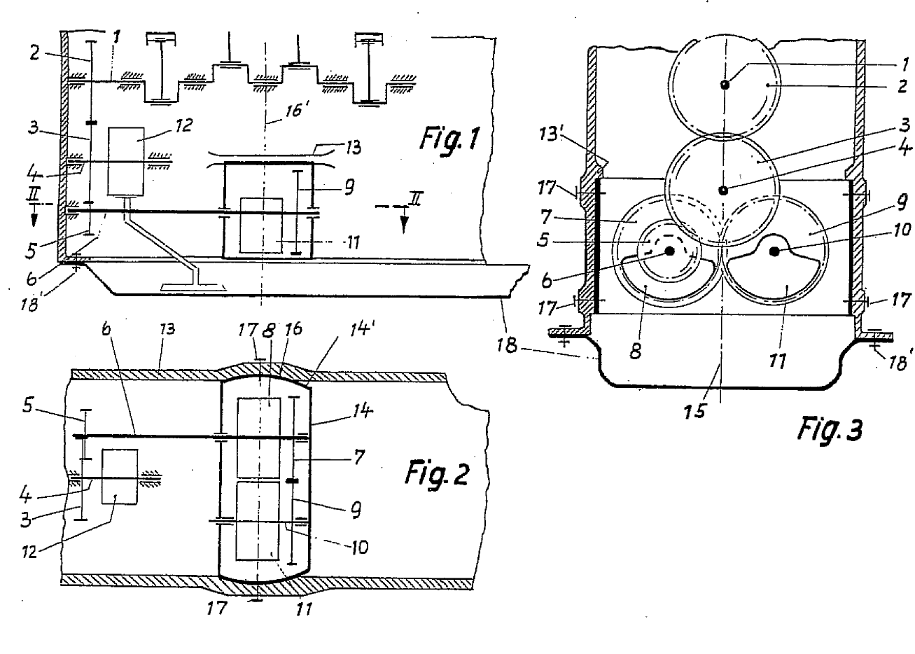

Referring to FIGS. 1 and 2, a first embodiment of an internal combustion engine comprises a crank housing 1, the lower part of said housing 1 preferably provided in the form of a ladder frame 1a which supports a crankshaft 2. The crankshaft 2 can be driven by pistons which are guided in cylinders and are coupled by connecting rods to the crankshaft 2 (not shown). The crank housing 1 and, respectively, the ladder frame 1a comprise a contact face 3. The contact face 3 generally serves as a flange for attaching an oil pan (not shown) and a mass balancing drive 4,

The mass balancing drive 4 comprises a housing 5 in which there are supported two equalizing shafts 6 which rotate in opposite directions and which are each provided with an unbalanced mass. The equalizing shafts 6 each comprise a driving gear 7, 8, said driving gears engaging one another. The driving gear 7 has a greater thickness than the driving gear 8 so that the driving gear 7 can be acted upon by an intermediate gear 9 which engages a crankshaft gear 10 carried by the crankshaft 2. The intermediate gear 9 drives the driving gear 7 and is preferably supported in a housing cover 11 of the housing 5. The housing cover 11 also covers the driving gears 7, 8, and is secured to the housing 5 of the mass balancing drive 4 by screws via at least three through-bores 14.

The housing cover 11 comprises a bore 13 for introducing a tool, for example a locating pin. The tool can further engage an axial bore of the equalizing shaft 6 carrying the driving gear 7. Engagement of the tool through the bore 13 and the axial bore of the shaft 6 affords the housing cover 11 with the intermediate gear 9 to pivot around the axis of the driving gear 7. As a result, the intermediate gear 9 is pivotable with a constant defined play around the axis of the driving gear 7. The two pitch circles of the intermediate gear 9 and of the driving gear 7 roll on one another when said gear 9 is pivoted by means of the housing cover 11. However, the intermediate gear 9—with the mass balancing drive 4 already having been mounted—carries out an almost vertical movement which, because of correspondingly specified tolerances, is limited to just a few degrees. As the distance between the equalizing shafts 6 and the crankshaft 2 remains constant, the intermediate gear 9 is rotated into the crankshaft gear 10 through a pivot movement.

The housing cover 11 with the mounted intermediate gear 9 is movable within the amount of play afforded by the fixing screws and the respective through-bores 14 of the housing cover 11, said screws and bores 14 further affording fixing of housing cover 11 to housing 5.

It is advisable for the housing cover 11 to be suitably stiff, so that it properly functions as a rigid lever arm.

For the purpose of setting the desired play between gears 9 and 10, the intermediate gear 9 is pivoted to a zero amount of play with reference to the crankshaft gear 10. The position of zero amount of play defines a distance A between the housing cover 11 and a contact face 3 of said housing 1. The value of the distance A can be determined using a sensor gauge, said gauge used, for example, at the location of a screw 12. A predetermined nominal value representative of the desired flank play between the gears 9, 10 is added to the value of distance A. Thereafter, an intermediate layer 15, whose thickness corresponds to the sum of the value of distance A and the predetermined nominal value, is arranged between the housing cover 11 and the contact face 3, for example at the position of the screw 12. The housing cover 11 is then properly positioned by tightening the screw 12 with a defined torque. In this way, the intermediate gear 9 is fixed in a desired position. Thereafter the fixing screws for fixing the housing cover 11 at the housing 5 are tightened. The tool (locating pin) can then be removed after completion of the setting procedure.

To aid in inserting the intermediate layer 15 between the housing cover I1 and the contact face 3, the housing cover 11 can initially be rotated back.

For this purpose, it should be common practice to stock intermediate layers 15 in the form of washers or the like with fine thickness graduations and select those which are closest to the nominal and actual values.

In a second embodiment of the present invention, there is provided a bore 16 in the housing 5, said bore 16 adapted to accept a tool, for example a locating pin. The bore 16 is located along a connecting line 17, said line 17 intersecting the axis of the intermediate gear 9 and the axis of the driving gear 7 driven, as shown in FIG. 1. The bore 16, with a tool inserted therein, affords a pivot axis in the same way bore 13 and the axial bore within shaft 6 affords a pivot axis in the first embodiment. As the angular deflection required for setting the tooth flank play is relatively small, the effect of displacing the pivot axis from bore 13 to bore 16 on the connecting line 17 is negligibly small. However, such an embodiment is advantageous in that the locating pin does not have to be removed after the setting procedure.

Instead of the housing cover 11 it is also possible to use a suitable clamp to support the intermediate gear 9.

Such a method permits simple and secure handling. Furthermore, the tooth flank play can be set while the mass balancing drive 4 is being mounted within the production line, without there being any need for complicated measuring procedures or the use of master gears. The accurate tooth flank play has to be determined only once in advance by calculations and tests and converted into an accurate distance measurement. The required distance measurement is obtained by adding the determined, existing distance dimension A and the theoretical distance dimension in order to obtain the required play.

1. A method of mounting a mass balancing drive (4) on a crank housing (1) of an internal combustion engine, which mass balancing drive (4) comprises two equalizing shafts (6) which are supported in a housing (5) and rotate in opposite directions, wherein in the crank housing (1) there is supported a crankshaft (2) which comprises a crankshaft gear (10), wherein the equalizing shafts (6) are drivable via two inter-engaging driving gears (7, 8) one of which is moved into a driving connection when the housing (5) of the mass balancing drive (4) is being fixed to a contact face (3) of the crank housing (1), characterised in that, between the crankshaft gear (10) and the following driving gear (7), there is arranged an intermediate gear (9) which is pivotable around an axis positioned on the connecting line of the axes of the intermediate gear (9) and of the driving gear (7) driven thereby, that after the housing (5) of the mass balancing differential drive (4) has been fixed, the intermediate gear (9) is swung around the axis up to the point of zero play between the intermediate gear (9) and the crankshaft gear (10), that the dimension of the distance between the housing (5) and the contact face (3) is measured at the point of zero play, that said measurement is used for determining the distance measurement required for obtaining the required flank play between the intermediate gear (9) and the crankshaft gear (10) and that an intermediate layer (15) corresponding to the flank play is inserted between the housing (5) and the contact face (3), whereupon the intermediate gear (9) is fixed.

2. A method according to claim 1, characterised in that the intermediate gear (9) is pivoted by a lever.

3. A method according to claim 2, characterised in that the a housing cover (11) is used as the lever.

4. A method according to claim 1, characterised in that the intermediate gear (9) is arranged so as to be pivotable around the axis of the driving gear (7) driven by same.

5. A method according to claim 1, characterised in that the lever is articulated at the housing (5) via a locating pin.

6. A method according to claim 5, characterised in that the locating pin is arranged in a bore so as to extend axially relative to the equalizing shaft (6) coupled to the driving gear (7) driven by the intermediate gear (9).

7. A method according to claim 5, characterised in that the locating pin is arranged in a bore on the connecting line of the axes of the intermediate gear (9) and the driving gear (7) driven thereby so as to extend parallel to the axis of the equalizing shaft (6) coupled to the driving gear (7) driven by the intermediate gear (9).

8. A mass balancing drive for an internal combustion engine, having a housing (5) in which there are supported two equalizing shafts (6) which rotate in opposite directions and which can be driven by two inter-engaging driving gears (7, 8), characterised in that an intermediate gear (9) which engages one of the driving gears (7) and which is pivotable around an axis positioned on the connecting line of the axes of the intermediate gear (9) and of the driving gear (7) driven thereby can be fixed in a predetermined position relative to the housing (5).

9. A mass balancing drive according to claim 8, characterised in that the intermediate gear (9) can be pivoted by a lever.

10. A mass balancing drive according to claim 9, characterised in that the lever is a housing cover (11).

11. A mass balancing drive according to claim 10, characterised in that the housing cover (11) is pivotable in accordance with the play of through-bores (14) for fixing screws for fixing the housing cover (11) at the housing (5).

12. A mass balancing drive according to claim 8, characterised in that the intermediate gear (9) is arranged so as to be pivotable around the axis of the driving gear (7) driven thereby.

13. A mass balancing drive according to claim 8, characterised in that the intermediate gear (9) is arranged so as to be pivotable around an axis on the connecting line of the axes of the intermediate gear (9) and the driving gear (7) driven thereby.

14. A mass balancing drive according to claim 8, characterised in that the pivot axis of the intermediate gear (9) is defined by a locating pin.

15. A mass balancing drive according to claim 14, characterised in that the locating pin is arranged in a bore on the connecting line of the axes of the intermediate gear (9) and of the driving gear (7) driven thereby so as to extend parallel to the axis of equalizing shaft (6) coupled to the driving gear (7) driven by the intermediate gear (9).

16. A method of mounting a mass balancing drive on a crank housing comprising:
providing a first housing and a second housing, an intermediate gear shaft having an intermediate shaft axis and an intermediate gear attached thereto, a first equalizing shaft having a first equalizing shaft axis and a first equalizing gear attached thereto, a second equalizing shaft having a second equalizing gear attached thereto and a crank shaft having a crank shaft gear attached thereto;
said first housing fixing the position and rotatably securing said intermediate gear shaft, said first equalizing shaft and said second equalizing shaft, wherein said intermediate gear of said intermediate gear shaft engages said first equalizing gear of said first equalizing shaft, said first equalizing gear of said first equalizing shaft also engages said second equalizing gear of said second equalizing shaft, and said first equalizing shaft and said second equalizing shaft rotate in opposite directions;
said second housing fixing the position and rotatably securing said crank shaft;
rotating said first housing about a pivot axis to a position of desired tooth flank play between said intermediate gear and said crank shaft gear; and
fixedly attaching said first housing to said second housing when said first housing is at said position of desired tooth flank play, for the purpose of mounting a mass balancing drive on a crank housing.

17. A method of claim 16, further comprising providing a lever, said lever rotating said intermediate gear shaft with said intermediate gear thereon.

18. A method of claim 17, wherein providing said first housing provides said lever.

19. A mass balancing drive for an internal combustion engine comprising:
an intermediate gear shaft having an intermediate gear shaft axis and an intermediate gear attached thereto, a first equalizing shaft having a first equalizing shaft axis and a first equalizing gear attached thereto, a second equalizing shaft having a second equalizing gear attached thereto and a crank shaft having a crank shaft gear attached thereto;
said intermediate, first equalizing and second equalizing shafts fixedly positioned and rotatably secured to a first housing, wherein said intermediate gear of said intermediate shaft engages said first equalizing gear of said first equalizing shaft, said first equalizing gear of said first equalizing shaft also engages said second equalizing gear of said second equalizing shaft, and said first equalizing shaft and said second equalizing shaft rotate in opposite directions;
said crank shaft fixedly positioned and rotatably secured to a second housing;
a connecting line, said line intersecting said intermediate gear shaft axis and said first equalizing shaft axis;
a pivot axis, said pivot axis located on said connecting line and passing at least partially through said first housing and said second housing, for the purpose of allowing said first housing to rotate about said pivot axis to a position of desired tooth flank play between said intermediate gear and said crank case gear.

20. The invention of claim 19, further comprising a lever.

21. The invention of claim 20, wherein said first housing is said lever.
